(19) United States
(12) Patent Application Publication
(10) Pub. No.: US 2019/0132524 A1
(43) Pub. Date: May 2, 2019

(54) IMAGE GENERATION METHOD, IMAGE GENERATION APPARATUS, AND DEFECT DETERMINATION METHOD USING IMAGE GENERATION METHOD AND IMAGE GENERATION APPARATUS

(71) Applicant: CANON KABUSHIKI KAISHA, Tokyo (JP)

(72) Inventors: Hidenori Hashiguchi, Utsunomiya-shi (JP); Takanori Uemura, Saitama-shi (JP)

(21) Appl. No.: 16/165,957

(22) Filed: Oct. 19, 2018

(30) Foreign Application Priority Data
Oct. 31, 2017 (JP) 2017-211222

(51) Int. Cl. H04N 5/232; G06T 7/00; H04N 5/225

(52) U.S. Cl. CPC H04N 5/23299; G06T 2207/20212; H04N 5/2256; G06T 7/0008

(57) ABSTRACT

An image generation method is provided and generates an image of a surface of a target object includes causing an image capturing unit placed at a first position to capture, as first image capturing, the surface of the target object through a periodic structure body including transmission regions and non-transmission regions having lower transmittance than the transmission regions alternately with a predetermined period P, causing an image capturing unit placed at a second position different from the first position to capture, as second image capturing, the surface of the target object through the periodic structure body, and generating the surface image using the first image and the second image, wherein the first and second positions are different from each other in a periodic direction of the periodic structure body.

### BACKGROUND

### Field

The present disclosure relates to an image generation method or an image generation apparatus for acquiring an image of an object to he inspected (target object) that has a surface with glossiness, and for generating a surface image for optically evaluating the target object.

### Description of the Related Art

As a technique for detecting a defect present on the surface of a work, which is a target object with glossiness, a technique for illuminating the work using a light source that emits light in a periodic striped pattern, and for capturing the light reflected by the work with a camera is known (Japanese Patent Application Laid-Open No. 2004-198263). An inspection method discussed in Japanese Patent Application Laid-Open No. 2004-198263 irradiates the work with light of which the luminance periodically changes. Then, the inspection method calculates an amplitude, a phase, and an average value of the changing luminance of a captured image of the reflected light. Further, the inspection method calculates the amplitude, the phase, and the average value at a plurality of positions while moving the work, thereby detecting detects on the entire work.

### SUMMARY

According to an embodiment, an image generation method for generating a surface image of a surface of a target object includes causing an image capturing unit placed at a first position to capture, as first image capturing, the surface of the target object through a periodic structure body including transmission regions and non-transmission regions having lower transmittance than the transmission regions alternately with a predetermined period P, causing an image capturing unit placed at a second position different from the first position to capture, as second image capturing, the surface of the target object through the periodic structure body, and generating the surface image using the first image and the second image, wherein the first and second positions are different from each other in a periodic direction of the periodic structure body.

Further features will become apparent from the following description of exemplary embodiments with reference to the attached drawings.

### BRIEF DESCRIPTION OF THE DRAWINGS

FIG. 1 is a schematic diagram illustrating an example of embodiment of an apparatus.

FIG. 2 is a diagram illustrating an illumination unit.

FIG. 3 is a cross-sectional view illustrating the illumination unit according to an exemplary embodiment.

FIG. 4 is a flowchart illustrating an inspection method for inspecting a defect on a surface of a work.

### DESCRIPTION OF THE EMBODIMENTS

In the inspection method discussed in Japanese Patent Application Laid-Open No. 2004-198263, a liquid crystal display (LCD) and a line patterned film are used in the light source for projecting the striped pattern onto the work. This line patterned film includes portions that do not transmit light. Therefore, this line patterned film functions as a mask having line-shaped light-blocking portions that do not transmit light. If the amplitude, the phase, and the average are calculated from an image influenced by the mask, noise having striped intensity distribution (hereinafter referred to as “stripe noise”) is generated. Thus, it is not possible to detect various defects on a gloss surface of the work with high accuracy.

The present disclosure is directed to an image generation method and an image generation apparatus for generating a surface image for detecting a defect on the surface of a work having glossiness with high accuracy.

Exemplary embodiments will be described below with reference to the attached drawings in the drawings, the same member or component is designated by the same reference number, and the redundant description of the same member or component is omitted or simplified. Although the following exemplary embodiments are described as an optical evaluation apparatus (an apparatus for executing a defect determination method or a defect determination apparatus) as an example, the exemplary embodiments may also be applied to an image generation method (or an apparatus) for generating an image for defect determination. In other words, in the exemplary embodiments, it is not always necessary to perform evaluation (i.e., determine the presence of a defect). The exemplary embodiments may only need to be applied to an image generation method (an image generation apparatus) for generating a surface image for optical evaluation (an image for facilitating the evaluation of the presence or absence of a defect).

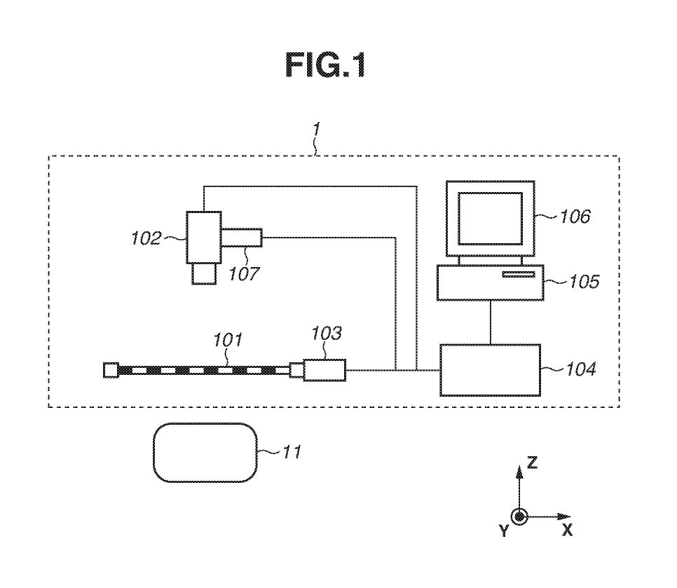

A description is given of an optical evaluation apparatus 1, which is an apparatus for processing an image of a target object (a work), according to a first exemplary embodiment. FIG. 1 is a schematic diagram illustrating the optical evaluation apparatus 1. The optical evaluation apparatus 1 optically evaluates a flat surface of a work 11 (a target object) with glossiness. In this case, “flat” may refer to the state where the surface as a whole (or an inspection region as an inspection target in the target object) is flat. Accordingly, even if the work 11 has a locally curved surface due to a small scratch or surface roughness, this state is, as a matter of course, included in “flat”. Further, even if the work 11 has a curved surface, but if the difference in the depth direction (i.e., the optical axis direction) of an image capturing unit at a position in the inspection region is within the depth of focus of the image capturing unit, this state can be regarded as a fiat surface.

The work 11 is, for example, a metal component or a resin component used for an industrial product with a polished surface. On the surface of the work 11, various defects including a scratch, color loss, and a defect having a gentle uneven shape, such as a dent, can occur. The optical evaluation apparatus 1 acquires an image of the surface of the work 11 and evaluates processed image information obtained by processing the acquired image, thereby detecting these defects described above. Then, based on the detection results, the optical evaluation apparatus 1 classifies the work 11 into, for example, anon-defective product or a defective product. The optical evaluation apparatus 1 can include a conveyance device (not illustrated) (e.g., a conveyer, a robot, a slider, or a manual stage) for conveying the work 11 to a predetermined position.

The optical evaluation apparatus 1 can include an illumination unit 101 for illuminating the work 11 and a camera. 102 (image capturing unit) for capturing the work 11 from above through the illumination unit 101. The camera 102 can use an image sensor in which pixels are arranged two-dimensionally, such as a charge-coupled device (CCD) image sensor or a complementary metal-oxide-semiconductor (CMOS) image sensor. Using such an area sensor camera, it is possible to acquire an image of a wider region than a line sensor camera at a time. Thus, it is possible to evaluate a wide range on the surface of a work at high speed.

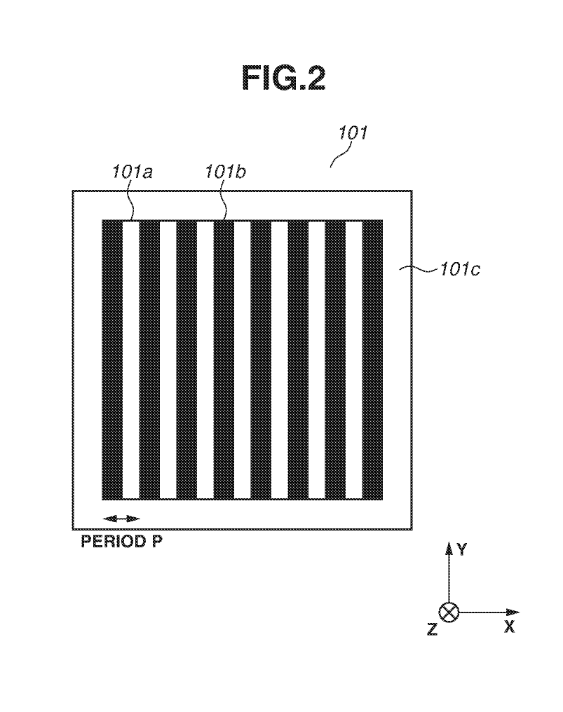

FIG. 2 is a diagram illustrating the illumination unit 101. The lumination unit 101 includes a periodic structure body (a structure body or a mask in which members different in the transmittance or the reflectance of light from each other are arranged periodically) in which transmission portions 101a and non-transmission portions 101b, which have lower transmittance than the transmission portions 101a, are arranged alternately. The plurality of line-shaped transmission portions 101a and the plurality of line-shaped non-transmission portions 101b are arranged alternately with a constant period P. A member including the transmission portions 101a, and the non-transmission portions 101b is held by a frame portion 101c. In this case, the transmission portions transmission regions) 101a may not be members, but may be regions where there is nothing. Specifically, the transmission portions 101a may be spaces there are no optical members) or regions surrounded by the non-transmission portions (non-transmission regions) 101b and the frame portion 101c. Further, “the periodic structure body (the mask)” may refer to a plurality of non-transmission portions thus arranged at constant intervals, or may collectively refer to non-transmission portions and spaces (transmission portions) each sandwiched by two of the non-transmission portions, or transmission members present in the spaces. As described above, the periodic structure body is a structure body in which transmission regions and non-transmission regions having approximately long and narrow rectangular shapes are arranged alternately along a periodic direction. Further, it is desirable that the periodic structure body should be able to move in the periodic direction (a direction perpendicular to the longitudinal direction of the transmission regions or the non-transmission regions). It is more desirable that a light-emitting unit and alight-guiding unit should also move integrally (or in conjunction) with the periodic structure body.

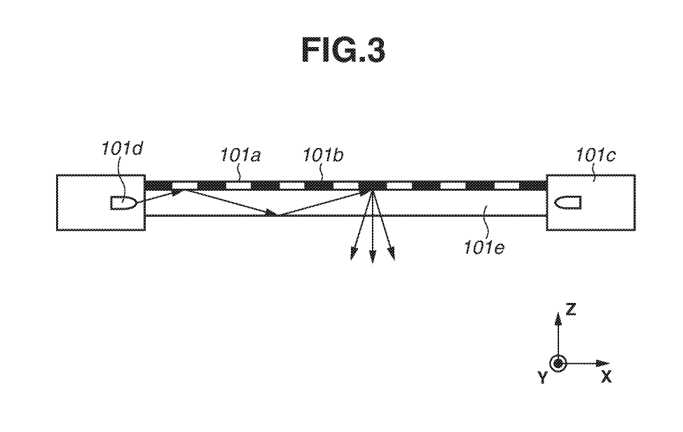

FIG. 3 is a cross-sectional view of a form of the illumination unit 101. The illumination unit 101 can further include light-emitting diodes (LEDs) (as light-emitting unit) 101d and a light-guiding plate 101e, which guides light from the LEDs 101d to the transmission portions 101a and the non-transmission portions 101b (scattering portions having higher scattering properties than the transmission portions 101a). The light-guiding plate 101e is, for example, a planar plate made of acrylic or glass. The non-transmission portions 101b may be obtained by, for example, printing a material with light-scattering properties in a striped pattern with the period P on a film. In this case, portions (regions) where this light-scattering material is not printed on the film are the transmission portions 101a. If the film on which such a pattern is printed is stuck tightly to the light-guiding plate 101e, the periodic structure body can be produced.

The plurality of LEDs 101d (or may be a single LED 101d) are provided a region within the frame portion 101c, which surrounds the transmission portions 101a and the non-transmission portions 101b. At least a part of light emitted from the LEDs 101d travels while being totally reflected within the light-guiding plate 101e. Since a material with light-scattering properties is used for the non-transmission portions 101b, a part of light incident on the non-transmission portions 101b is scattered toward the work 11. On the other hand, the transmission portions 101a scatter little light. Thus, little light is emitted from the transmission portions 101a toward the work 11. Consequently, the illumination unit 101 projects striped pattern light onto the work 11. A part of the light reflected (or scattered) by the work 11 is blocked by the non-transmission portions 101b of the illumination unit 101, and the other part of the light is transmitted through the transmission portions 101a of the illumination unit 101. The camera 102 can capture the work 11 using the transmitted light. In the optical evaluation apparatus 1 according to the present exemplary embodiment, the camera 102 is focused on the surface of the work 11.

In the present exemplary embodiment, the transmission portions 101a and the non-transmission portions 101b are achieved by a striped pattern printed on a film using a material with light-scattering properties, but are not limited to the configuration of such an illumination unit. For example, the transmission portions 101a may be line-shaped apertures as described above, and the non-transmission portions 101b may be composed of line-shaped light-emitting members.

As illustrated in FIG. 1, the illumination unit 101 is held by a movable mechanism 103, which is a driving unit. The movable mechanism 103 can move the illumination unit 101 in a direction (an X-direction in FIG. 1) orthogonal to the lines of the transmission portions 101a and the non-transmission portions 101b. Although the movable mechanism 103 moves the illumination unit 101 in the present exemplary embodiment, the work 11 may be moved relative to the illumination unit 101, changing the relative position between the illumination unit 101 and the work 11. Further, only the transmission portions 101a and the non-transmission portions 101b (the periodic structure body) may be moved without moving the entire illumination unit 101. In this case, it is desirable that when images are captured a plurality of times (while images are being captured a plurality of times), the positional phases of the respective images should be different from each other. In other words, it is desirable that the target object should be captured a plurality of times by moving the periodic structure body by a distance less than the period P. Further, images may be successively (intermittently) captured while moving the periodic structure body by the period P (an image may be captured with respect to each amount of movement less than the period P). Alternatively, images may be captured by continuously exposing the periodic structure body while moving the periodic structure body by the period P (by moving the periodic structure body during the process of capturing the images), whereby it is possible to reduce the adverse influence of the capturing of an image through the periodic structure body.

The optical evaluation apparatus 1 further includes a movable mechanism 107 for driving the camera 102. The movable mechanism 107 can move the camera 102 in a direction (the X-direction in FIG. 1; the periodic direction of the period P) orthogonal to the lines (the longitudinal directions) of the transmission portions 101a and the non-transmission portions 101b of the illumination unit 101. Although the movable mechanism 107 moves the camera 102 in the present exemplary embodiment, the work 11 may be moved relative to the camera 102, thereby changing the relative position between the camera 102 and the work 11. Further, instead of translation operation of the camera 102 or the work 11 in the X-direction, the camera 102 or the work 11 may be driven to change the angle between the optical axis of the camera 102 and the work 11.

The movable mechanisms 103 and 107 are connected to a control unit 104. The control unit 104 is composed of, for example, a board including a central processing unit (CPU) and a memory and synchronously controls the illumination unit 101, the camera. 102, and the movable mechanisms 103 and 107. The control unit 104 controls the movable mechanism 103 to move the illumination unit 101 by ΔXi (i=1, 2, . . . , N) and controls the camera 102 to capture N images (N≥3). Further, the control unit 104 controls the movable mechanism 107 to change the relative position between the camera 102 and the work 11 and then controls the camera 102 to capture images while moving the illumination unit 101 again. More specifically, the control unit 104 controls the movable mechanism 103 to move the illumination unit 101 by ΔXi (i=1, 2, . . . , M) and controls the camera 102 to capture M images (M≥3). ΔXi may only need to be known at this time and therefore can be set to any magnitude. The present invention, however, is not limited to such a configuration. Alternatively, for example, the work 11 may be moved by manually operating the movable mechanism 103 and then captured by the camera 102, using a manual trigger.

The optical evaluation apparatus 1 can further include a personal computer (PC) 105, which is an image processing unit, and a display 106. The PC 105 according to the present exemplary embodiment has the function of evaluating the surface of the work 11 (determining the presence or absence of a defect, or determining a defect) based on information regarding images (a first image and a second image) obtained by the camera 102. The PC 105 and the control unit 104 may not be provided separately, and the PC 105 (image processing unit) may be provided integrally with the control unit 104. Further, the image processing unit may not be a general-purpose PC, but may be a machine dedicated to image processing. Images captured by the camera 102 are transferred to the PC 105 via a cable (not illustrated).

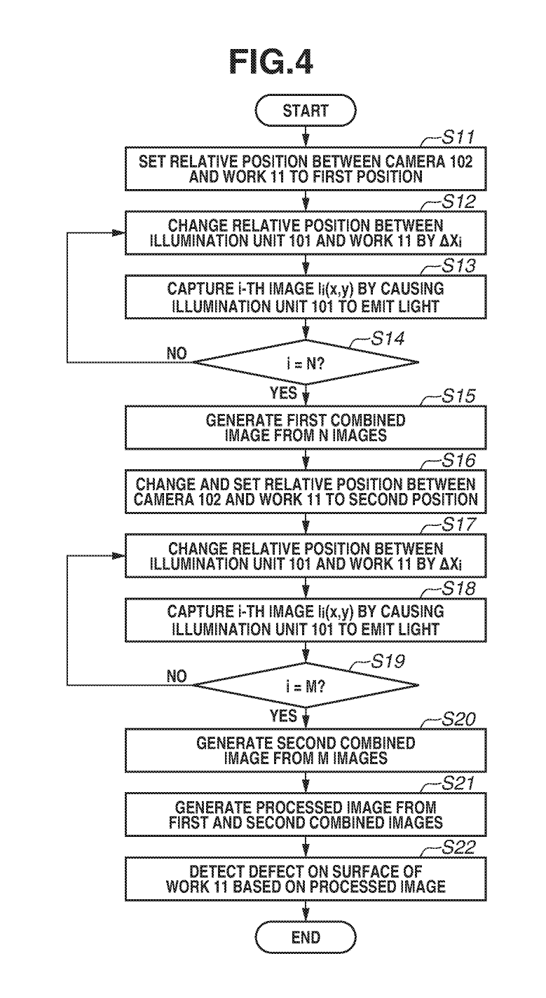

FIG. 4 illustrates an inspection method for inspecting a defect on the surface of a work using the optical evaluation apparatus 1 according to the present exempt embodiment. In step S11, the movable mechanism 107 moves the camera 102, thereby setting the relative position between the camera 102 and the work 11 to a first position so that an inspection region in the work 11 is in the field of view of the camera 102. In step S12, the movable mechanism 103 moves the illumination unit 101, thereby changing the relative position between the illumination unit 101 and the work 11 by ΔX1 relative to a reference position in step S13, a first image I1(x,y) is captured by causing the illumination unit 101 to emit light at this position. x and y represent the position of a pixel on the image. In this case, ΔX1 may be zero, and the first image I1(x,y) may be captured at the reference position. Next, in step S12, the movable mechanism 103 moves the illumination unit 101, thereby changing the relative position between the illumination unit 101 and the work 11 by ΔX2 relative to the reference position. In FIG. 4, i in ΔXi counts up (increases from 1) every time the processing returns from step S14 to step S12. ΔX1, ΔX2, . . . , and ΔXN are values different from each other. If i reaches N (Yes in step S14), the processing proceeds to step S15. Next, in step S13, a second image I2(x,y) is captured by causing the illumination unit 101 to emit light at this position. This processing is repeated N times, thereby capturing a total of N (N≥3) images.

In step S15, a first combined image is generated from the N images using information regarding the change in the intensity of a frequency component of which the phase shifts by 4πΔXi/P radians in a case where the relative position between the illumination unit 101 and the work 11 changes by ΔXi.

An example of the combined image is an amplitude image having a frequency component of which the phase shifts by 4πΔXi/P radians (in a case where the work 11 has a planar surface, a frequency component corresponding to a striped pattern with a period of P/2 that occurs on an image). If the relative position between the illumination unit 101 and the work 11 is shifted at steps having a width of P/N, ΔXi (i=1, 2, . . . , N) is represented by the following formula.

ΔXi=(P/N)×(i−1)

This formula includes a case where ΔX1 is zero. If the first image I1(x,y) is changed from the reference position, the following formula is obtained.

ΔXi=(P/N)×i

At this time, an amplitude image A(x,y) can be calculated by the following formula. This is a processed image including information obtained by processing the N (N≥3) images and regarding the surface of the target object, and is also a processed image generated using information regarding the change in the intensity of a frequency component of which the phase shifts by 4πΔXi/P radians.

$$A ( x , y ) = \sqrt{{I}_{sin}^{2} ( x , y ) + {I}_{cos}^{2} ( x , y )} \\ {I}_{sin}^{ } ( x , y ) = {\sum }_{n = 0}^{N - 1} {I}_{n + 1} ( x , y ) sin ( 4 π n / N ) \\ {I}_{cos}^{ } ( x , y ) = {\sum }_{n = 0}^{N - 1} {I}_{n + 1} ( x , y ) cos ( 4 π n / N ) \qquad ( 1 )$$

If the position of the illumination unit 101 is moved, the positions of light points and dark points on the image sensor of the camera 102 also move. Thus, the light and dark in intensity change at one point on pixels of the camera 102. In a suffice portion that concerns the work 11 with glossiness and has normal gloss on its surface, an amplitude corresponding to the difference between the light and dark occurs.

In a suffice portion having a scattering defect such as minute unevenness or surface roughness on a surface of the work 11, scattered light occurs in addition to specularly reflected light. If scattered light is present, a part of the scattered light is blocked by the non-transmission portions 101b at the light points on the image sensor of the camera 102. This reduces brightness of the points. On the other hand, a part of the scattered light is transmitted through the transmission portions 101a at the dark points on the image sensor of the camera 102. This increases brightness of the dark points.

As a result, the difference between the light and dark becomes small, and the value of the amplitude also becomes small. For example, on a perfectly diffusing surface, the distribution of the light scattering angle does not depend on the angle of incident light. Thus, even if the illumination unit 101 projects a striped pattern onto the work 11, the distribution of the light scattering angle is always uniform, and the amplitude is zero. Thus, in the amplitude image, the degree of scattering property can be evaluated as a surface texture. Thus, information of a scattering defect such as a scratch, minute unevenness, or surface roughness can be obtained. The information of the scattering defect can also be visualized. In this case, a “texture” refers to the properties and the state of an object. A “surface texture” refers to the properties and the state of a surface including a scratch, minute unevenness, surface roughness, and scattering property on the surface of the work 11 (the target object).

Another example of the combined image is a phase image having a frequency component of which the phase shifts by 4πΔXi/P radians. A phase image θ(x,y) can be calculated by the following formula.

$$θ ( x , y ) = {tan}^{- 1} ( \frac{{I}_{sin} ( x , y )}{{I}_{cos} ( x , y )} ) \qquad ( 2 )$$

In the above formula, the phase is calculated by a value of −π to π. Thus, if the phase changes beyond this value, a discontinuous phase jump occurs in the phase image. For this reason, phase connection (phase unwrapping) is required as necessary.

In the phase image, an inclination of the surface of the work 11 can be evaluated as a surface texture. Thus, in the phase image, information of a defect due to a gentle shape change, such as a dent, surface tilting, or a surface depression, can be obtained. The information of the defect can also be visualized.

Although various algorithms are discussed for phase connection (phase unwrapping), an error can occur in a case where noise in the image is large. As a method for avoiding phase connection, phase differences corresponding to the differentiation of the phase may he calculated. Phase differences Δθx(x,y) and Δθy(x,y) can be calculated by the following formula.

$${Δθ}_{x} ( x , y ) = {tan}^{- 1} ( \frac{{I}_{cos}^{ } ( x , y ) {I}_{cos}^{ } ( x - 1 , y ) + {I}_{sin}^{ } ( x , y ) {I}_{sin}^{ } ( x - 1 , y )}{{I}_{sin}^{ } ( x , y ) {I}_{cos}^{ } ( x - 1 , y ) - {I}_{cos}^{ } ( x , y ) {I}_{sin}^{ } ( x - 1 , y )} ) \\ {Δθ}_{y} ( x , y ) = {tan}^{- 1} ( \frac{{I}_{cos}^{ } ( x , y ) {I}_{cos}^{ } ( x , y - 1 ) + {I}_{sin}^{ } ( x , y ) {I}_{sin}^{ } ( x , y - 1 )}{{I}_{sin}^{ } ( x , y ) {I}_{cos}^{ } ( x , y - 1 ) - {I}_{cos}^{ } ( x , y ) {I}_{sin}^{ } ( x , y - 1 )} ) \qquad ( 3 )$$

Yet another example of the combined image is an average image. An average image Iave(x,y) can be calculated by the following formula.

$${I}_{ave}^{ } ( x , y ) = \frac{1}{N} {\sum }_{n = 1}^{N} {I}_{n} ( x , y ) \qquad ( 4 )$$

In the average image, the distribution of reflectance can be evaluated as a surface texture. Thus, in the average image, information of a defect different in reflectance from a normal portion, such as color loss, dirt, or an absorbent foreign material, can be obtained. The information of the defect can also be visualized.

As described above, between the amplitude image, the phase image or the phase difference image, and the average image, surface textures that can be optically evaluated are different, and as a result, defects to be visualized are also different. Thus, these images are combined together, whereby it is possible to evaluate various surface textures and visualize various defects.

However, it has been found that stripe noise is generated in the above-described amplitude image, the phase image or the phase difference image, and the average image. Specifically, this stripe noise has a period of P×L/2D, where the distance from the work 11 to the pupil plane of the camera 102 is L, the optical path length from the work 11 to the illumination unit 101 is D, and the period of the transmission portions 101a and the non-transmission portions 101b of the illumination unit 101 is P. To correct this noise, a first combined image at a first position and a second combined image at a second position are acquired, and a processed image is calculated.

Referring back to FIG. 4, in step S16, the movable mechanism 107 moves the camera 102 with (P×L/4D), which is a half period of the stripe noise, thereby setting the relative position between the camera 102 and the work 11 to a second position. Further, in step S17, the movable mechanism 103 moves the illumination unit 101, thereby changing the relative position between the illumination unit 101 and the work 11 by ΔX1 relative to a reference position. Next, in step S18, a first image I1(x,y) is captured by causing the illumination unit 101 to emit light at this position. Next, in step S17, the movable mechanism 103 moves the illumination unit 101, thereby changing the relative position between the illumination unit 101 and the work 11 to ΔX2 relative to the reference position. As described above in steps S12 to S14, i in ΔXi and Ii in steps S17, S18, and S19 also counts up every time the processing returns from step S19 to step S17. If i reaches M (Yes in step S19), the processing proceeds to step S20.

In step S18, a second image I2(x,y) is captured by causing the illumination unit 101 to emit light at this position. This processing is repeated M times, thereby capturing a total of M (it is desirable that M≥3, but 2 may be acceptable) images.

In step S20, a second combined image is generated from the M images using information regarding the change in the intensity of a frequency component of which the phase shifts by 4πΔXi/P radians in a case where the relative position between the illumination unit 101 and the work 11 changes by ΔXi.

In step S21, alignment is performed between the first and second combined images so that each pixel corresponds to the same pixel position in the work 11, and the first and second combined images are added together, thereby generating a processed image (a surface image or an evaluation image). That is, an image generation unit (a calculator or a CPU) adds together a first combined image obtained by combining a plurality of images captured by a camera at a first position, and a second combined image obtained by combining a plurality of images captured by the camera at a second position, taking into account the shift amounts of the respective combined images. In other words, a plurality of images captured at each viewpoint is combined together for each viewpoint, and the images from the different viewpoints are combined together, taking into account the positions of (a work in) the images. At this time, it is desirable to add together (or combine) the images, also taking into account aberration of the optical system of the camera, or a condition that changes depending on the position of the camera.

Finally, in step S22, a defect on the surface of the work 11 is detected from the processed image. As described above, defects are visualized in the first and second combined images, and further, by utilizing the processed image of the first and second combined images, it is possible to perform a quality inspection of the work 11 with high accuracy.

In the present exemplary embodiment, in step S16, the amount of movement of the camera 102 is a half period (P×L/4D) of the stripe noise, which reduces the stripe noise most effectively. The present invention, however, is not limited to this. For example, if the amount of movement of the camera 102 is

(n+1/4)L×P/2D or more and (n+3/4)L×P/2D or less,

where n is any integer, it is possible to obtain the effect of reducing the stripe noise. In this case, the amount of movement of the camera 102 can also be represented as the amount of movement of the optical axis of a camera (an image capturing unit) (i.e., the distance between optical axes at two positions), or the amount of shift in the intersection of the optical axis of the camera and a target object (i.e., the distance between intersections). In this case, it may be more desirable that the amount of movement of the camera 102 should be

(n+3/8)L×P/2D or more and (n+5/8)L×P/2D or less.

Further, in this case, the amount of movement of the camera 102 can be simply less than the period P.

Further, in the present exemplary embodiment, the camera 102 is translated in the X-direction. Alternatively, the work 11 may be able to be translated in the X-direction, and the camera 102 or the work 11 may be movable, thereby changing the angle between the optical axis of the camera 102 and the work 11. For example, in the state where a camera (an image capturing unit) and the surface of a work (a target object) are inclined at a first angle, and the state where the camera and the surface of the work are inclined at a second angle different from the first angle, the camera may capture the surface of the work, in this case, a driving unit for driving the work minutely changes the inclination angle of the work every time an image is captured or a driving unit for driving the camera minutely changes the inclination angle of the optical axis of the camera (or the amount of eccentricity of some of lenses) every time an image is captured. At this time, it is desirable that the inclination angle (or the tilt amount) should be an angle in a rotational direction about an axis parallel to the longitudinal direction of non-transmission regions of a periodic structure body (a mask). The inclination angle, however, may be slightly shifted (5 degrees or less).

Further, it is desirable that the difference in inclination Δθ of the work between first and second positions should satisfy

(n+1/4)×P/D<tan(2Δθ)<(n+3/4)×P/D.

If the work is inclined by Δθ, a light source image is shifted by D tan(2Δθ) relative to a mask image. When this shift amount is 1/4 to 3/4, preferably 1/2, of a pitch, i.e., when tan(2Δθ)=P/2D, the stripe noise is corrected most suitably.

The optical evaluation apparatus 1 according to the present exemplary embodiment generates a processed image including information regarding the surface of the work 11, detects a defect from the processed image, and for example, performs a quality inspection of the work 11. However, an apparatus such as the optical evaluation apparatus 1 according to the present invention is used not only to detect a defect on the surface of the work 11. For example, an apparatus to which the present invention can be applied may be used to measure the shape of the surface of a work using the information of the phase image including the information of the inclination of the surface of the work 11. Further, an apparatus to which the present invention can be applied may be used to measure glossiness using the information of the amplitude image including the information regarding the scattering behavior of the surface of the work 11.

In the present exemplary embodiment, the target object is captured at the first and second positions. Alternatively, the target object may be captured at more positions, and combined images at the respective positions may be added together. For example, images can be captured at N positions (N is an integer) shifted from each other with a period of 1/N of a noise period of P×L/2D.

According to the configuration of the present exemplary embodiment, it is possible to provide an image generation method and an image generation apparatus for generating a surface image for detecting with high accuracy a defect on the surface of a work with glossiness.

### Other Embodiments

Embodiments of the present invention can also be realized by a computer of a system or apparatus that reads out and executes computer executable instructions one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Bleu-ray Disc (AD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-211222, filed Oct. 31, 2017, which is hereby incorporated by reference herein in its entirety.

What is claimed is:

1. An image generation method for generating a surface image of a surface of a target object, the image generation method comprising:
causing an image capturing unit placed at a first position to capture, as first image capturing, the surface of the target object through a periodic structure body including transmission regions and non-transmission regions having lower transmittance than the transmission regions that are arranged alternately with a predetermined period P in a periodic direction;
causing an image capturing unit placed at a second position different from the first position to capture, as second image capturing, the surface of the target object through the periodic structure body; and
generating the surface image using a first captured image obtained in the first image capturing and the second captured image obtained in the second capturing,
wherein the first and second positions are different from each other in the periodic direction of the periodic structure body.

2. The image generation method according to claim 1, wherein the image capturing unit that captures the first image in the first image capturing and the image capturing unit that captures the second image in the second image capturing are the same image capturing units.

3. The image generation method according to claim 1, wherein after the first image capturing and before the second image capturing, the image capturing unit is moved from the first position to the second position.

4. The image generation method according to claim 1, wherein a distance between the first and second positions in the periodic direction of the periodic structure body is less than the period P.

5. The image generation method according to claim 1, wherein a distance between an intersection of an optical axis of the image capturing unit located at the first position and the target object and an intersection of an optical axis of the image capturing unit located at the second position and the target object in the periodic direction of the periodic structure body is
(n+1/4)L×P/2D or more and (n+3/4)L×P/2D or less,
Where a distance from the surface of the target object to a pupil plane of the image capturing unit is L, an optical path length from the surface of the target object to the periodic structure body is D, and n is any integer.

6. The image generation method according to claim 1,
wherein, in the first image capturing, the image capturing unit captures the target object multiple times in a plurality of states where positions of the periodic structure body are different in each of the plurality of states, and
wherein, in the second image capturing, the image capturing unit captures the target object multiple times in a plurality of states where positions of the periodic structure body are different in each of the plurality of states.

7. The image generation method according to claim 6, wherein, in the periodic direction, a minimum difference of the plurality of positions of the periodic structure body in the plurality of states is less than the period P.

8. The image generation method according to claim 6, wherein, in the plurality of states, a light-emitting unit configured to emit light for illuminating the target object moves in conjunction with the periodic structure body.

9. The image generation method according to claim 1, wherein generating the surface image includes aligning the first captured image and the second captured image in an inspection region in the target object, and combining the first captured image and the second captured image.

10. The image generation method according to claim 1, wherein the surface of the target object is flat.

11. The image generation method according to claim 1, wherein the image capturing unit that captures the second captured image is tilted relative to the image capturing unit that captures the first captured image.

12. An image generation method for generating a surface image of a surface of a target object, the image generation method comprising:
in a case where an image capturing unit and the surface of the target object are inclined at a first angle, causing the image capturing unit to capture, as a first image, the surface of the target object through a periodic structure body in which transmission regions and non-transmission regions having lower transmittance than the transmission regions are provided alternately with a predetermined period P;
in a state where an image capturing unit and the surface of the target object are inclined at a second angle different from the first angle, causing the image capturing unit to capture, as second image, the surface of the target object through the periodic structure body; and
generating the surface image using the first image and the second image.

13. The image generation method according to claim 12, wherein each of the first and second angles is an angle in a rotational direction about an axis parallel to a longitudinal direction of the non-transmission regions included in the periodic structure body.

14. The image generation method according to claim 12, wherein a difference in inclination Δθ of the target object between the first and second angles satisfies
(n+1/4)×P/2D<tan(2Δθ)<(n+3/4)×P/2D,
Where an optical path length from the target object to the periodic structure body is D, and n is any integer.

15. An image generation apparatus for generating a surface image of a surface of a target object, the image generation apparatus comprising;
a periodic structure body in which transmission regions and non-transmission regions having lower transmittance than the transmission regions are provided alternately with a predetermined period P;
a an image capturing unit configured to capture the surface of the target object through the periodic structure body;
a driving unit configured to drive the image capturing unit;
an image generation unit configured to generate the surface image based on an image captured by the image capturing unit; and
a control unit configured to, in a state where the image capturing unit is placed at a first position, cause the image capturing unit to capture the surface of the target object, thereby acquiring a first image, and in a case where the control unit controls the driving unit to place the image capturing unit at a second position different from the first position, cause the image capturing unit to capture the surface of the target object, thereby acquiring a second image, and cause the image generation unit to generate the surface image using the first and second images.

16. An image generation apparatus for generating a surface image of a surface of a target object, the image generation apparatus comprising:
periodic structure body in which transmission regions and non-transmission regions having lower transmittance than the transmission regions are provided alternately with a predetermined period P;
a first image capturing unit placed at a first position and configured to capture the surface of the object to be inspected through the periodic structure body;
a second image capturing unit placed at a second position different from the first position and configured to capture the surface of the target object through the periodic structure body;
an image generation unit configured to generate the surface image based on images captured by the first and second image capturing units; and
a control unit configured to cause the first image capturing unit to capture the surface of the target object, thereby acquiring a first image, cause the second image capturing unit to capture the surface of the target object, thereby acquiring a second image, and cause the image generation unit to generate the surface image using the first and second images.

17. An image generation apparatus for generating a surface image of a surface of a target object, the image generation apparatus comprising:
a periodic structure body in which transmission regions and non-transmission regions having lower transmittance than the transmission regions are provided alternately with a predetermined period P;
a driving unit configured to change an inclination of the surface of the target object;
an image capturing unit configured to capture the surface of the target object through the periodic structure body;
an image generation unit configured to generate the surface image based on an image captured by the image capturing unit; and
a control unit configured to, in a state where the image capturing unit and the surface of the object to be inspected are inclined at a first angle, cause the image capturing unit to capture the surface of the target object, thereby acquiring a first image, and in a state where the image capturing unit and the surface of the target object are inclined at a second angle different from the first angle, cause the image capturing unit to capture the surface of the target object, thereby acquiring a second image, and cause the image generation unit to generate the surface image using the first and second images.

18. A detect determination method for determining a detect on a surface of a target object, the defect determination method comprising:
generating the surface image of the surface of the object to be inspected, by the image generation method according to claim 1; and
determining whether a defect is present on the surface of the object to be inspected, based on the surface image.
